(19) United States
(12) Patent Application Publication
(10) Pub. No.: US 2010/0302095 A1
(43) Pub. Date: Dec. 2, 2010

(54) SYSTEM FOR SHARING GPS PROTOCOL DATA AND METHOD THEREOF

(75) Inventor: Chia-Chin Yu, Hsinchu (TW)

Correspondence Address: QUINTERO LAW OFFICE, PC, 615 Hampton Dr, Suite A202, Venice, CA, 90291, US

(73) Assignee: MITAC TECHNOLOGY CORP., Hsinchu (TW)

(21) Appl. No.: 12/477,042

(22) Filed: Jun. 2, 2009

(51) Int. Cl. G01S 1/00; G01S 19/03

(52) U.S. Cl. 342/357.4

(57) ABSTRACT

A system for sharing GPS protocol data is described. In the system, raw GPS protocol data from a satellite is obtained by a GPS receiver. A GPS protocol data server is connected to the GPS receiver through a physical serial port, so as to obtain the GPS protocol data. A service application program is execute on the GPS protocol data server, and provides a service of resolving the GPS protocol data or converting the format thereof through a TCP/IP based multi-thread communication procedure. A virtual serial port driver is used to generate a plurality of virtual serial ports, and each virtual serial port communicates with the service application program through the TCP/IP protocol. Therefore, application devices or application programs respectively communicates with the service application program through the virtual serial ports, thereby obtaining the service of parsing the GPS protocol data provided by the service application program.

### BACKGROUND OF THE INVENTION

1. Field of the Invention

The present invention relates to global positioning systems (GPS), and more particularly to a system for sharing GPS protocol data and a method thereof, capable of sharing the GPS protocol data among a plurality of application devices or application programs.

2. Related Art

The development and applications of Global Positioning System (GPS) is initiated by the U.S. Department of Defense, and the GPS technology was only used in military at early time Recently, GPS is widely applied to commercial purpose. A GPS system includes 24 GPS satellites in the outer space, 1 master control station, 3 data upload stations, 5 monitor stations, and GPS receivers at subscriber ends.

The most popular one of the commercial GPS receivers is the GPS receiver used for vehicle navigation. In general, the GPS receiver transmits GPS protocol data through serial ports (a.k.a. COM Ports), and when the GPS protocol data is transferred during communication, a most commonly used communication protocol is national marine electronics association (NMEA) (for example, NMEA-0183 protocol). An application device of the subscriber end is, for example, a personal digital assistant (PDA) or a navigation device, the application device is connected to the GPS receiver through a serial port, so as to obtain the GPS protocol data (for example, NMEA Data or SiRF Binary Data), and then the application device obtains geographic data of a position of the GPS receiver through parsing the GPS protocol data. However, being limited by the serial port, the GPS protocol data transmitted by the GPS receiver cannot be utilized by two or more application devices or application programs.

Recently, software solving the problem by establishing virtual serial ports has been developed. Similar to a software pipes, the GPS protocol data is directly guided in and out these virtual serial ports, such that different application devices or application programs may obtain the GPS protocol data by being connected to different virtual serial ports. However, in the method, GPS commands sent by the application devices or the application programs of the subscriber end are directly transmitted to the GPS receiver without being appropriately processed, such that other application devices or application programs sharing the software pipe are easily disordered.

In the conventional art, the virtual COM port (serial port) is used to receive GPS protocol data, but is only limited to a COM port format capable of be accepted by a geographic information system (GIS) map engine module. For a subscriber end, only one GIS map engine module may use the satellite coordinate data, and the satellite coordinate data cannot be utilized by two or more application devices or application programs. In addition, in the prior art, a service of converting the GPS protocol data having different formats is not provided. For example, if the two application devices or application programs respectively require the GPS protocol data having different formats, such as NMEA and SiRF Binary, in the prior art, the application devices or the application programs respectively using the GPS protocol data having the two different formats cannot be served.

### SUMMARY OF THE INVENTION

The present invention is directed to a system for sharing GPS protocol data, which is used to provide the GPS protocol data to a plurality of clients (such as a plurality of application device or application programs) for use.

In order to achieve the above object, the system for sharing the GPS protocol data according to a preferred embodiment of the present invention includes a GPS receiver, a GPS protocol data server, a service application program, and a virtual serial port driver.

The GPS receiver receives raw GPS protocol data from a satellite.

The GPS protocol data server has a physical serial port for establishing a communication with the GPS receiver to obtain the raw GPS protocol data (NMEA, SiRF Binary, Other . . . ), and has a communication interface.

The service application program is executed on the GPS protocol data server, and includes a GPS protocol data parsing procedure for parsing the raw GPS protocol data, and a transfer control protocol/Internet protocol (TCP/IP) based multi-thread communication procedure. The service application program is for providing a TCP/IP based communication service through the communication interface, so as to serve service requests from the clients and provide the parsed GPS protocol data.

The virtual serial port driver provides a plurality of virtual serial ports for a plurality of clients to establish communication connections. Each virtual serial port communicates with the service application program of the GPS protocol data, so the plurality of clients respectively communicate with the service application program through the virtual serial ports, thus obtaining the GPS protocol data provided by the service application program.

The present invention is further directed to a system for sharing GPS protocol data, for providing the GPS protocol data to a plurality of clients for use, and providing a format converting service. The system accepts service requests from the plurality of clients, so as to provide the GPS protocol data having different formats.

In order to achieve the above object, the system for sharing the GPS protocol data according to the present invention further has a GPS protocol data converting procedure, which is capable of accepting service requests from a plurality of clients, and converting a certain GPS protocol data format to another GPS protocol data format.

The present invention further provides a method for sharing GPS protocol data, which includes the following steps.

In step A, raw GPS protocol data from a satellite is obtained.

In step B, a plurality of virtual serial ports is provided for being connected to a plurality of clients, and service requests from the clients are obtained.

In step C, a service application program is executed to parse the raw GPS protocol data, so as to provide a service of resolving the GPS protocol data.

In step D, the service requests of parsing the GPS protocol data from the clients are sent to the service application program.

In step E, the service application program responds to the service requests from the clients through a TCP/IP based multi-thread communication path.

The advantages of the present invention are:

1. The problem that one GPS receiver may only be started and utilized by a single application device or application program is solved. Through the technique of the present invention, the GPS receiver may be started and simultaneously utilized by a plurality of application devices or application programs intending to read the GPS protocol signal data.

2. The GPS protocol data server is simulated as a plurality of real GPS receivers through software, but has a stronger function. The common GPS receiver may only output the GPS protocol data format of one communication protocol at the same time, however, through the GPS protocol data converting procedure of the present invention, the raw GPS protocol data is converted to various GPS protocol data having different formats through processing by the software.

3. A certain application device or application program of the client may be served. According to the service requests from the application device or the application program to the service application program, the setting of reading the GPS protocol data of the application device or the application program, such as the format of the output GPS protocol data, the GPS protocol, or transfer rate, may be modified. The service application program of the present invention provides the services for the clients by utilizing the TCP/IP based multi-thread communication procedure, such that other application devices or application programs of the client are not interfered.

4. The GPS protocol data of the GPS receiver may be read by a remote end (non-Local end) application device or application program. The service application program of the present invention provides the services for the clients by utilizing the TCP/IP based multi-thread communication procedure, so that the distal end application device or application program may access thereto.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a system according to a first preferred embodiment of the present invention;

FIG. 2 is a flow chart of main steps of a method according to the present invention;

FIG. 3 is a block diagram of the system according to another preferred embodiment of the present invention; and

FIG. 4 is a block diagram of the system according to still another preferred embodiment of the present invention.

### DETAILED DESCRIPTION OF THE INVENTION

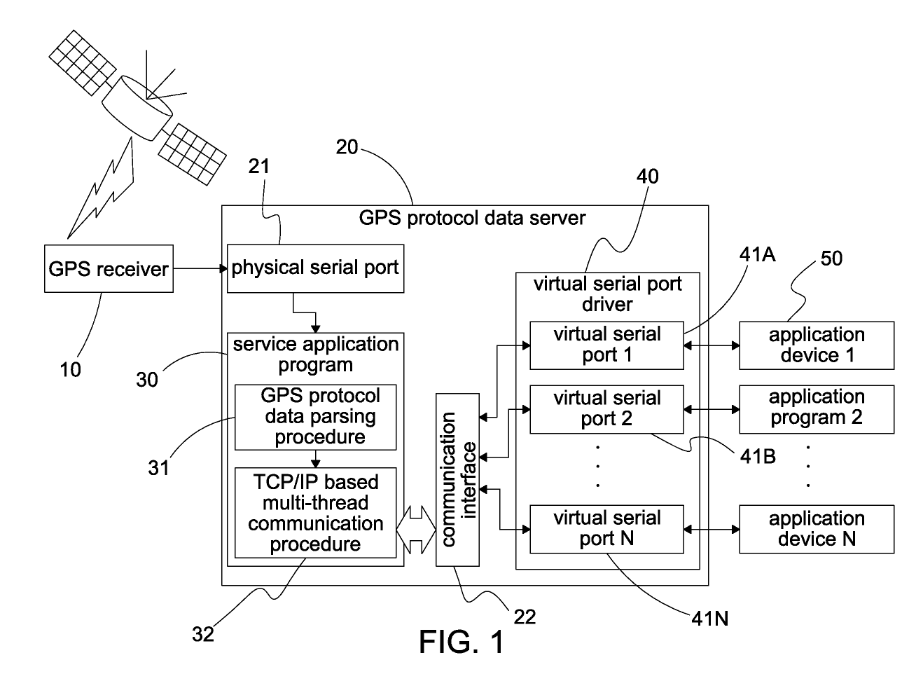

Referring to FIG. 1, a preferred embodiment of the present invention is provided. A system for sharing GPS protocol data provides raw GPS protocol data from a satellite to a plurality of clients for use, and the clients may be a plurality of application devices or application programs 50. The system includes a GPS receiver 10, a GPS protocol data server 20, a service application program 30, and a virtual serial port driver 40.

The GPS receiver 10 receives raw GPS protocol data from a satellite.

The GPS protocol data server 20 has a physical serial port 21 (physical serial port/physical COM Port) for establishing a communication with the GPS receiver 10 to obtain the raw GPS protocol data, and has a communication interface 22 for communicating with the clients. Preferably, the communication interface may be a network interface card (NIC) or a wireless local area network (WLAN) card.

The service application program 30 is executed on the GPS protocol data server 20, and includes a GPS protocol data parsing procedure 31 and a TCP/IP based multi-thread communication procedure 32. The GPS protocol parsing procedure 31 is provided for parsing the raw GPS protocol data of different communication protocols (such as NMEA, SiRF Binary . . . ), and is used to parse the received raw GPS protocol data to the data including one or any combination of longitude, latitude, height, speed, and time. The service application program 30 provides a TCP/IP based communication service through the communication interface 22, so as to serve service requests from the clients, for example, to provide the parsed GPS protocol data or the raw GPS protocol data, or a transfer rate of the GPS protocol data.

The virtual serial port driver 40 simulates a plurality of virtual serial ports 41A, 41B and 41N. Each virtual serial port 41A, 41B and 41N communicates with the service application program 30 through the TCP/IP protocol, so the application devices or the application programs 50 of the clients may respectively establish communication connections with the virtual serial ports 41A, 41B, and 41N, so as to obtain the GPS protocol data or the raw GPS protocol data parsed by the service application program 30 through the virtual serial ports 41A, 41B, and 41N. In addition, the application devices or the application programs 50 of the clients may send service requests or operating instructions to the service application program 30 through the virtual serial ports 41A, 41B, and 41N.

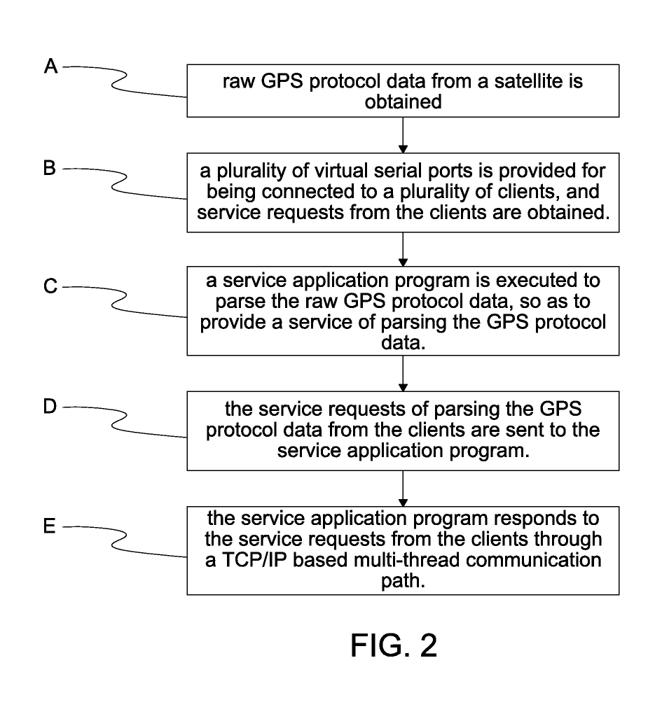

Referring to FIG. 2, a method according to the present invention includes the steps as follows.

In step A, raw GPS protocol data from a satellite is obtained.

In step B, a plurality of virtual serial ports is provided for being connected to a plurality of clients, and service requests from the clients are obtained.

In step C, a service application program is executed to parse the raw GPS protocol data, so as to provide a service of parsing the GPS protocol data.

In step D, the service requests of parsing the GPS protocol data from the clients are sent to the service application program.

In step E, the service application program responds to the service requests from the clients through a TCP/IP based multi-thread communication path.

The service application program 30 of the present invention provides the service for the clients by utilizing the TCP/IP based multi-thread communication procedure 32, such that the service requests or the operating instructions from the plurality of clients are not interfered with each other. In a preferred embodiment according to the prevent invention, the GPS protocol data server 20 may be implemented as a server, a desktop computer, a laptop computer, or other computer devices. The virtual serial port driver 40 may be directly executed on the GPS protocol data server 20 (as shown in FIG. 1), for simulating the plurality of virtual serial ports 41A, 41B, and 41N on the GPS protocol data server 20, such that the plurality of clients may obtain the GPS protocol data or the raw GPS protocol data parsed by the service application program 30 through the virtual serial ports 41A, 41B, and 41N.

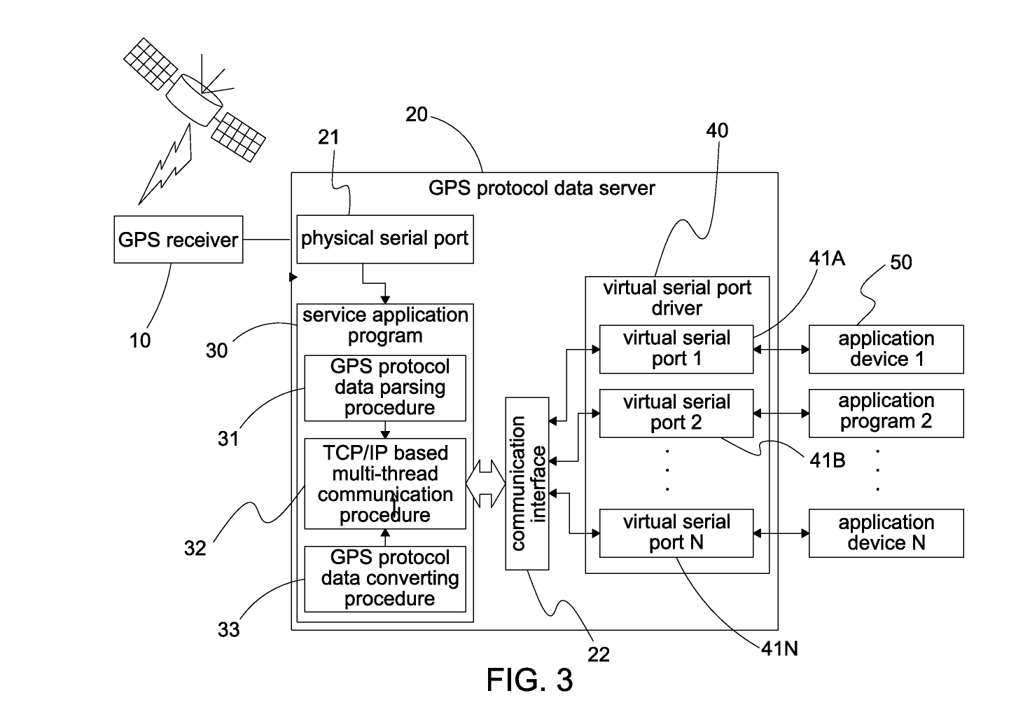

Referring to FIG. 3, in another preferred embodiment according to the present invention, a GPS protocol data converting procedure 33 is further arranged in the service application program 30. The service application program 30 may convert the GPS protocol data having a certain data format to the GPS protocol data having another data format by utilizing the GPS protocol data converting procedure 33 according to the requests from the clients. For example, the GPS protocol data converting procedure 33 converts the GPS protocol data having the NMEA format to the GPS protocol data having the SiRF Binary format, or the GPS protocol data converting procedure 33 converts the GPS protocol data having the SiRF Binary format to the GPS protocol data having the NMEA format. Then, the GPS protocol data is provided to two or more clients, application devices or application programs for use.

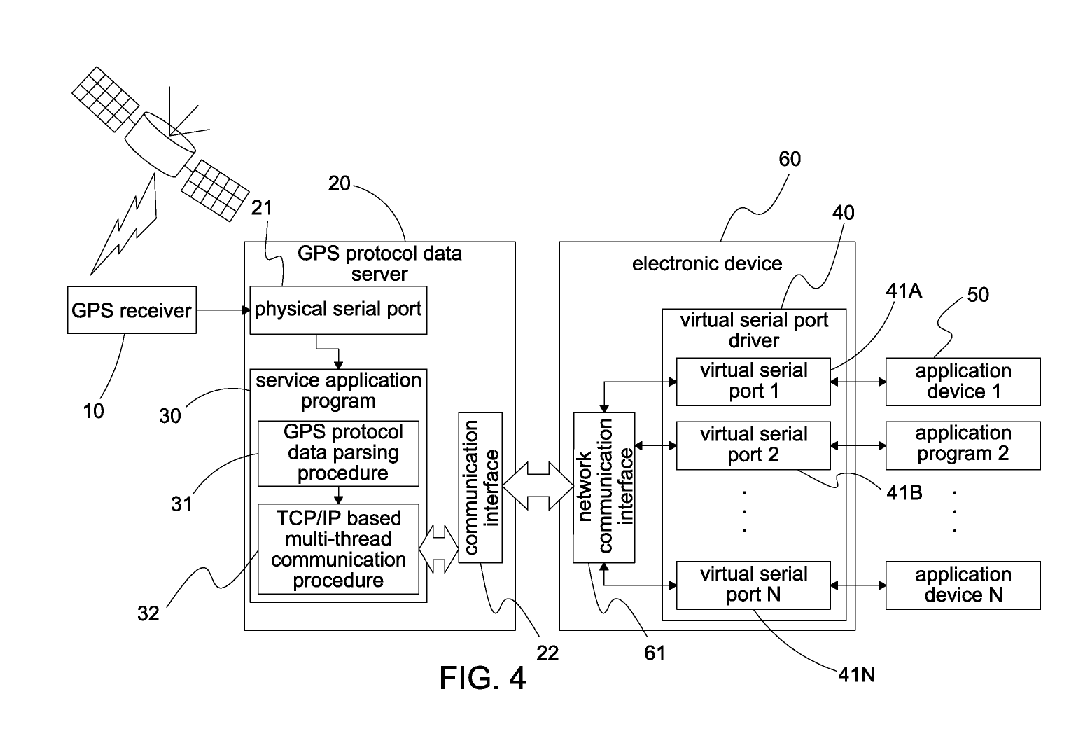

Referring to FIG. 4, in another embodiment according to the present invention, the virtual serial port driver 40 is executed on an electronic device 60, for example, a desktop computer or a laptop computer. The electronic device 60 further has a network communication interface 61. The network communication interface 61 may be the NIC or the wireless LAN card, and may establish the communication with the service application program 30 through the TCP/IP protocol. The virtual serial port driver 40 simulates the plurality of virtual serial ports 41A, 41B, and 41N in the electronic device 60, so the plurality of clients, application devices, or application programs 50 respectively establish the communication connection with the virtual serial ports 41A, 41B, and 41N, so as to obtain the parsed GPS protocol data or the raw GPS protocol data provided by the service application program 30 through the virtual serial ports 41A, 41B, and 41N. In addition, the plurality of clients, application devices, or application programs 50 may send the service requests or the operating instructions to the service application program 30 through the virtual serial ports 41A, 41B, and 41N, for example, the requests for changing the transfer rate of the GPS protocol data by the service application program 30, converting the GPS protocol data having different data formats, or providing the raw GPS protocol data.

What is claimed is:

1. A system for sharing GPS protocol data from a satellite to a plurality of clients, comprising:
a GPS receiver, receiving the raw GPS protocol data from the satellite;
a GPS protocol data server, having a physical serial port for establishing communication with the GPS receiver to obtain the raw GPS protocol data, and a communication interface for communicating with the clients;
a service application program, executed on the GPS protocol data server, and the service application program comprising:
a GPS protocol data parsing procedure for parsing the raw GPS protocol data of different communication protocols, and
a multi-thread TCP/IP-based communication procedure, providing a TCP/IP based communication service through the communication interface to serve service requests from the clients and provide the parsed GPS protocol data; and
a virtual serial port driver, simulating a plurality of virtual serial ports, through each of the virtual serial ports the service application program being communicated therewith, wherein the clients are arranged such that the clients respectively establish communication connections with the virtual serial ports to obtain the raw GPS protocol data or the parsed GPS protocol data provided by the service application program through the virtual serial ports, or the clients send the service requests or operating instructions to the service application program through the virtual serial ports.

2. The system for sharing GPS protocol data as claimed in claim 1, wherein the communication interface is a network interface card or a wireless local area network card.

3. The system for sharing GPS protocol data as claimed in claim 1, wherein in the GPS protocol data parsing procedure, the raw GPS protocol data is parsed to one or any combination of longitude, latitude, height, speed, and time.

4. The system for sharing GPS protocol data as claimed in claim 1, wherein the service application program changes a transfer rate of the GPS protocol data according to the service requests from the clients.

5. The system for sharing GPS protocol data as claimed in claim 1, wherein the service application program further has a GPS protocol data converting procedure converting GPS protocol data of a certain format to GPS protocol data of another format according to the requests from the clients.

6. The system for sharing GPS protocol data as claimed in claim 5, wherein the GPS protocol data converting procedure converts GPS protocol data of a NEMA format to GPS protocol data of a SiRF Binary format, or converts the GPS protocol data of the NMEA format to the SiRF Binary format.

7. The system for sharing GPS protocol data as claimed in claim 1, wherein the virtual serial port driver is executed on the GPS protocol data server.

8. The system for sharing GPS protocol data as claimed in claim 1, wherein the virtual serial port driver is executed on an electronic device, and the electronic device has a network communication interface for establishing the communication with the service application program through a TCP/IP protocol.

9. The system for sharing GPS protocol data as claimed in claim 8, wherein the electronic device is a desktop computer or a laptop computer.

10. A method for sharing GPS protocol data from a satellite to a plurality of clients, comprising the steps of:
obtaining raw GPS protocol data from the satellite;
providing a plurality of virtual serial ports for connecting to the clients respectively and obtaining service requests from the clients;
executing a service application program to parse the raw GPS protocol data, so as to provide a service of parsing the GPS protocol data;
sending the service requests of parsing the GPS protocol data from the clients to the service application program; and
responding the service requests from the clients by the service application program through a TCP/IP based multi-thread communication path.

11. The method for sharing GPS protocol data as claimed in claim 10, wherein the raw GPS protocol data from the satellite is obtained by a GPS receiver, and the service application program is connected to the GPS receiver through a physical serial port, so as to obtain the raw GPS protocol data.

12. The method for sharing GPS protocol data as claimed in claim 10, wherein the virtual serial port is generated by executing a virtual serial port driver.

13. The method for sharing GPS protocol data as claimed in claim 12, wherein the virtual serial port driver is executed on an electronic device, and the electronic device has a network communication interface for establishing a communication with the service application program through a TCP/IP protocol, for sending the service requests of parsing the GPS protocol data from the clients to the service application program through the TCP/IP protocol.

14. The method for sharing GPS protocol data as claimed in claim 12, wherein the service application program and the virtual serial port driver are executed on a server.

15. The method for sharing GPS protocol data as claimed in claim 10, further comprising a step of changing a transfer rate of the GPS protocol data by utilizing the service application program according to the service request from the client.

16. The method for sharing GPS protocol data as claimed in claim 10, further comprising a step of parsing the raw GPS protocol data by utilizing the service application program to the GPS protocol data comprising one or any combination of longitude, latitude, height, speed, time, and other data.

17. The method for sharing GPS protocol data according claim 16, further comprising a step of converting GPS protocol data of a certain format to GPS protocol data of another format by utilizing the service application program.

18. The method for sharing GPS protocol data according claim 17, comprising a step of converting GPS protocol data of a NMEA format to GPS protocol data of a SiRF Binary format.

19. The method for sharing GPS protocol data according claim 17, comprising a step of converting GPS protocol data of a SiRF Binary format to GPS protocol data of an NMEA format.
